(19) United States
(12) Patent Application Publication
(10) Pub. No.: US 2004/0026427 A1
(43) Pub. Date: Feb. 12, 2004

(54) Fuel tank mounting structure for fuel-cell vehicle

(76) Inventor: Satoshi Shigematsu, Kanagawa (JP)

Correspondence Address: FOLEY AND LARDNER, SUITE 500, 3000 K STREET NW, WASHINGTON, DC, 20007, US

(21) Appl. No.: 10/450,033

(22) PCT Filed: Sep. 4, 2002
(86) PCT No.: PCT/JP02/08984

(30) Foreign Application Priority Data
Oct. 10, 2001 (JP) 2001-312685

(51) Int. Cl. B60P 3/00; B62D 33/00; B65D 88/12

(52) U.S. Cl. 220/562

(57) ABSTRACT

A fuel tank (2) disposed on a floor (1) in a rear portion of a vehicle body is housed inside a housing box (4), which is provided with an upper portion thereof having a ventilation pipe (7) connected to the outside of a vehicle. Accordingly, leakage of fuel gas having a small molecular weight, does not affect the inside of a compartment because the fuel gas is discharged out of the vehicle through the ventilation pipe (7). In addition, the housing box (4) is separated into a lower box (5) and an upper box (6) to be fitted to the outside thereof. Therefore, an operation of inserting or detaching the fuel tank (2) is not interfered by detaching the upper box (6).

### TECHNICAL FIELD

The present invention relates to a structure for mounting a fuel tank, which is filled with fuel for a fuel cell of, for example, H₂ gas or alcohol, on a fuel-cell vehicle.

### BACKGROUND ART

Japanese Patent Application Laid-Open No. 9-290648 discloses a structure for mounting a cylinder filled with a fuel gas. This structure is provided with a support frame on a floor in a rear portion of a vehicle body such as a trunk space or a luggage space, in which a fuel cylinder is clamped on the support frame.

### DISCLOSURE OF THE INVENTION

As mentionedabove, sufficient safety measures are required in the case of mounting a fuel tank in a region such as the inside of a trunk space or a luggage space, where the influx of gas into a compartment supposed to secure safety of passengers might be conceivable. Particularly, a fuel-cell vehicle uses hydrogen as the fuel for a cell, in other words, as reactive gas. Accordingly, it is essential to prevent the reactive gas from flowing into the compartment in light of the worst case of breakage.

Therefore, in addition to the above-described conventional mounting structure, it is necessary to house the fuel tank and surrounding fuel supply pipes into a hermetically sealed space from the viewpoint of safety. In order to securely prevent influx of hydrogen having the smallest molecular weight into the compartment, a bulkhead structure is required, in which no parting lines exist to form the hermetically sealed space. Nevertheless, such a structure causes a problem of inhibiting installation or detachment of the fuel tank or maintenance of the fuel supply pipe.

It is an object to provide a fuel tank mounting structure for a fuel-cell vehicle, by means of which it is possible to mounting a fuel tank completely separately from the inside of a compartment so as not to interfere with maintenance of the fuel tank.

To achieve the object described above, the present invention provides a fuel tank mounting structure, comprising: a lower box fixed to the floor in a rear portion of a vehicle body for surrounding a fuel tank disposed thereon; an upper box mounted to the outside of the lower box for enclosing the fuel tank; a housing box constituted by the lower box and the upper box; and a ventilation pipe provided on the upper box for connecting an inner side of the housing box and an outer side of a vehicle.

### BRIEF DESCRIPTION OF THE DRAWINGS

FIG. 1 is a perspective view showing a first embodiment of the present invention;

FIG. 2 is a cross-sectional view taken along the II-II line in FIG. 1;

FIG. 3 is a cross-sectional perspective view showing a portion of a ventilation pipe penetrating a vehicle body according to the first embodiment of the present invention;

FIG. 4 is a perspective view showing a second embodiment of the present invention;

FIG. 5 is a cross-sectional view taken along the V-V line in FIG. 4;

FIG. 6 is a perspective view showing a third embodiment of the present invention;

FIG. 7 is a cross-sectional view taken along the VII-VII line in FIG. 6;

FIG. 8 is a perspective view showing a midstream in an installing or detaching process of a fuel tank according to the third embodiment of the present invention;

FIG. 9 is a perspective view showing a fourth embodiment of the present invention;

FIG. 10 is a cross-sectional view taken along the X-X line in FIG. 9;

FIG. 11 is a side view of the fourth embodiment of the present invention; and

FIG. 12A is an explanatory side view showing midstream of a mounting or detaching process of an upper box according to the fourth embodiment of the present invention.

FIG. 12B is an explanatory side view showing midstream of a detaching process of an upper box according to the fourth embodiment of the present invention.

### BEST MODE FOR VEHICLERYING OUT THE INVENTION

To describe the present invention in more detail, preferred embodiments of the present invention will be explained with reference to the drawings below.

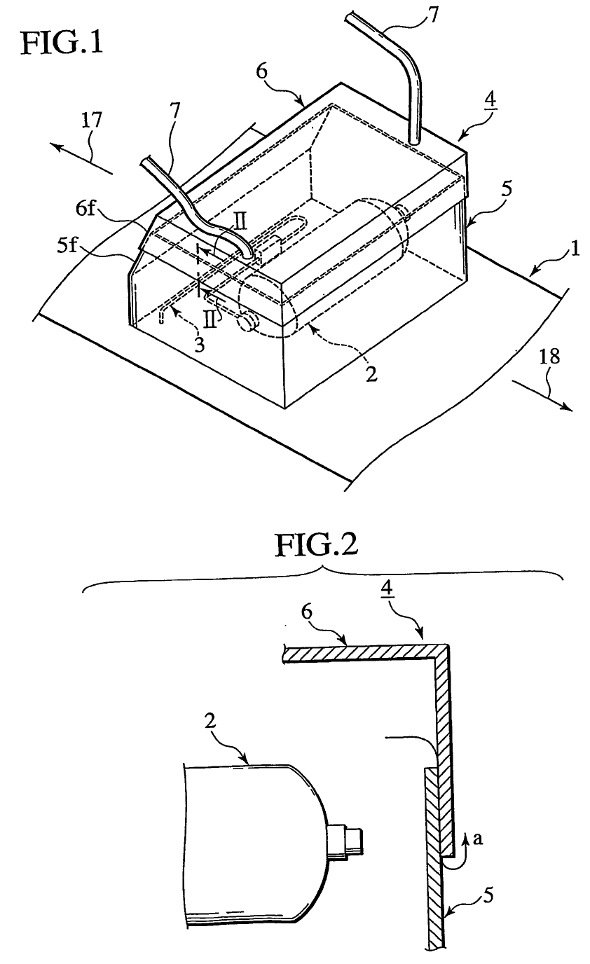

In FIG. 1, reference numeral 1 denotes a floor of a rear portion of a vehicle body such as a luggage space or a trunk space. A fuel tank 2 filled with a fuel gas having a small molecular weight such as hydrogen, and a fuel supply pipe 3 connected to the fuel tank 2 are fixed and disposed to predetermined positions on the floor 1 by appropriate fixing means.

Reference numeral 4 denotes a metallic housing box disposed on the floor 1 for housing the fuel tank 2 and the fuel supply pipe 3. The housing box 4 is formed as a plane quadrangle. The housing box 4 is constituted separately by a lower box 5 and an upper box 6. The lower box 5 surrounds the fuel tank 2 and the fuel supply pipe 3, and back-and-front and right-and-left side walls thereof are fixed to the floor 1 by welding. The upper box 6 is designed to be fitted to the outside of the lower box 5 from above so as to enclose the fuel tank 2 and the like. In a pair of side portions where the lower box 5 and the upper box 6 mutually overlap, and which face each other, for example, mating faces 5f and 6f on a front side portion of a pair of back-and-front side portions are formed as inclined planes.

On both right and left sides of an upper wall of the upper box 6, ventilation pipes 7 are disposed, for connecting the inside of the housing box 4 and the outside of a vehicle. As shown in FIG. 3, an upper end of the ventilation pipe 7 penetrates a side portion 8 of the vehicle body such as a rear pillar, and is connected thereto. Moreover, the outside of the vehicle is furnished with a finisher 9 having a louver. Reference numeral 17 denotes the front of the vehicle, and Reference numeral 18 denotes the rear of the vehicle.

According to the above-described constitution of the embodiment, in a case where fuel gas such as hydrogen leaks out of the fuel tank 2 or the fuel supply pipe 3 connected thereto, the fuel gas, having a small molecular weight, is oriented upward and thereby is discharged out of the vehicle via the ventilation pipe 7 above the housing box 4.

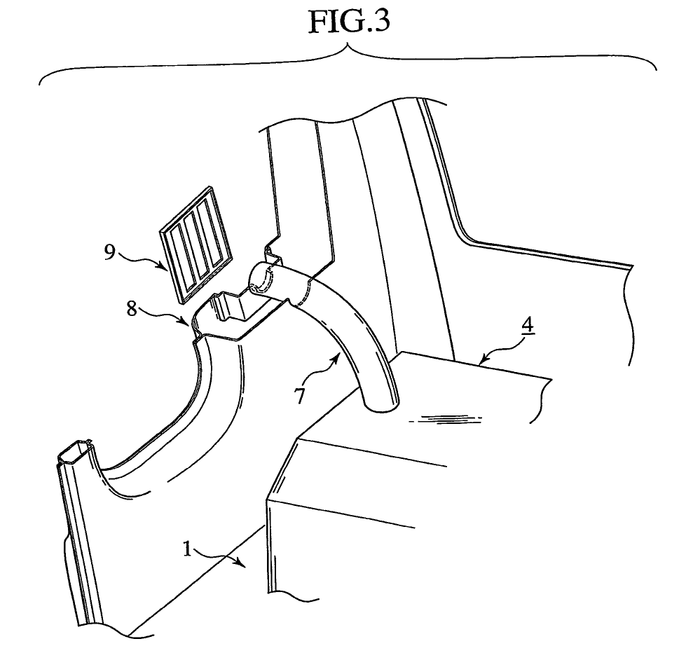

The housing box 4 houses the fuel tank 2 and the like by fitting the upper box 6 to the outside of the lower box 5 on the floor 1. Accordingly, a space between the overlapping mating faces of the lower box 5 and the upper box 6 may constitute a communication path for the fuel as illustrated with an arrow in FIG. 2. However, the path in the direction from the inside of the housing box 4 toward the outside constitutes a downward path at the space between the mating faces. Accordingly, fuel gas with a small molecular weight such as hydrogen hardly does not easily enter the space between the mating faces, being in a downward direction. Therefore, the fuel gas follows a discharge path through the ventilation pipe 7 as described above. As a result, it is possible to prevent the fuel gas from flowing into the compartment and thereby to enhance security.

As described above, the housing box 4 has a constitution in which the lower box 5 to be fixed onto the floor 1 and the upper box 6 to be covered thereon are provided separately. Accordingly, it is possible to conduct the insertion and detachment of the fuel tank 2 or maintenance operations of the fuel supply pipe 3 easily by detaching the upper box 6.

The front mating faces 5f and 6f of the lower box 5 and the upper box 6 are formed as inclined planes. Accordingly, it is possible to align the upper box 6 with the lower box 5 by slidably matching the inclined planes 5f and 6f with each other. Therefore, it is possible to easily conduct an operation for fitting the upper box 6.

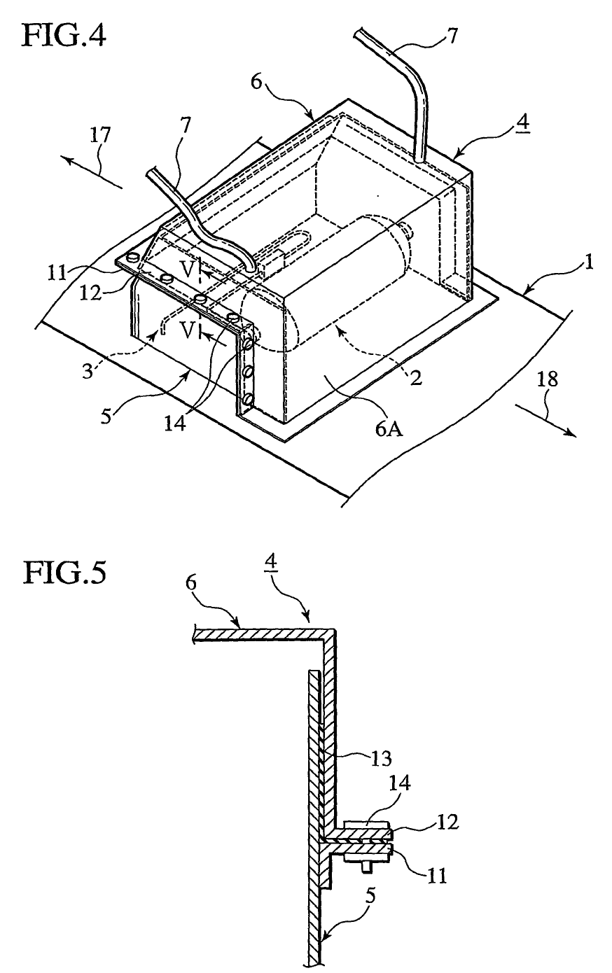

FIGS. 4 and 5 show a second embodiment of the present invention. In the second embodiment, a back side portion of the lower box 5 in the first embodiment is made open and constituted as an open side portion. On a back side of the upper box 6, an extended portion 6A is formed for covering the open side portion of the lower box 5. On an outer face in the vicinity of an aperture edge of the lower box 5, a flange 11 is formed along the aperture edge. On an aperture peripheral edge across the extended portion 6A of the upper box 6, a peripheral flange 12 is formed so as to overlap the flange 11 of the lower box 5 and the floor 1. In a space between the mating faces of the lower box 5 and the upper box 6 and a space between the overlapping faces of the flange 11 and the peripheral flange 12, a sealing member 13 made of butyl rubber, for example, is interposed therein. The upper box 6 is fixed to the lower box 5 by fastening the overlapping portions of the flange 11 and the peripheral flange 12 with bolts and nuts 14.

Similar effects to those in the first embodiment can be obtained according to the structure of the second embodiment. In addition, since the back side portion of the lower box 5 is formed as an open side portion, it is possible to open an unillustrated gating body such as a back door and to insert or detach the fuel tank 2 to or from the lower box 5 through the open side portion by horizontal displacement. Therefore, it is possible to conduct an easily inserting and detaching operation of the fuel tank 2.

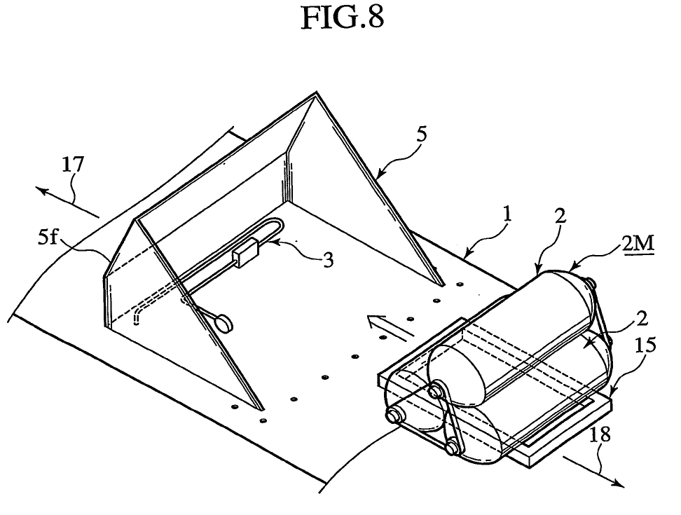

As shown in FIG. 8, a module type 2M constituted by a plurality of fuel tanks 2 set together on a support frame 15 becomes considerably heavy. However, even in this case, it is possible to insert or detach the module 2M into or out of the lower box 5 easily by horizontal displacement.

The sealing member 13 is interposed across the space between the mating faces of the lower box 5 and the upper box 6 and the space between the overlapping faces of the flange 11 of the lower box 5 and the peripheral flange 12 of the upper box 6. In addition, the lower box 5 and the upper box 6 are fastened and fixed together with the bolts and the nuts 14 at the overlapping portions of the flange 11 and the peripheral flange 12 so as not to penetrate the inside of the boxes. Therefore, effluence of the fuel gas through a path formed between the mating faces of the lower box 5 and the upper box 6 can be securely prevented.

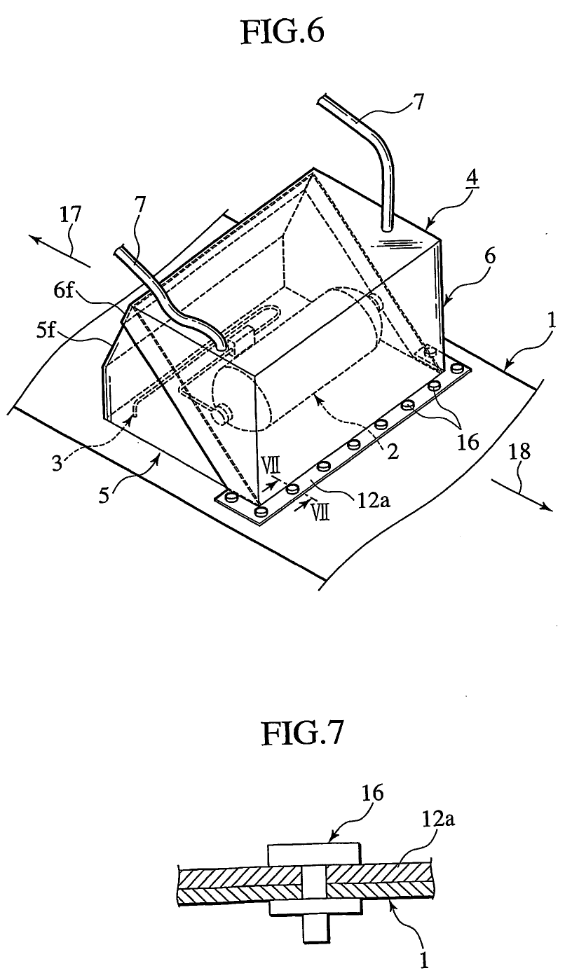

FIGS. 6 to 8 show a third embodiment of the present invention. In the third embodiment, the lower box 5 and the upper box 6 are constituted separately such that aperture edges thereof slant from the mating faces 5f and 6f formed as the inclined planes onto the floor 1 from a side view. A flange 12a is formed on an edge portion on a lower slant end side of the aperture edge of the upper box 6, which contacts with the floor 1. The upper box 6 is fastened and fixed to the floor 1 via the flange 12a with bolts and nuts 16.

Similar effects to those in the first embodiment can be obtained according to the structure of the third embodiment. In addition, since the back side portion of the lower box 5 is set to an open state, similar to the second embodiment, it is possible to insert or detach the fuel tank module 2M, for example, to or from the lower box 5 through this back side portion of the open side portion by horizontal displacement, and it is possible to easily conduct an inserting and detaching operation thereof. By slidably fitting a lower edge of a front end of the upper box 6 onto the slanted aperture edge of the lower box 5, it is possible to conduct an operation of fitting or detaching the upper box 6 to or from the lower box 5. Accordingly, it is possible to easily conduct an inserting and detaching operation of the upper box 6 while reducing labor energy.

The mating faces 5f and 6f formed as the inclined faces engage with each other on an upper slanted end portion of the aperture edges of the lower box 5 and the upper box 6, that is, on the front end side. Accordingly, the upper box 6 can be fixed securely just by fastening and thereby fixing the flange 12a onto the floor 1 with the bolts and the nuts 16. Therefore, it is possible to reduce the man-hours of a fastening operation.

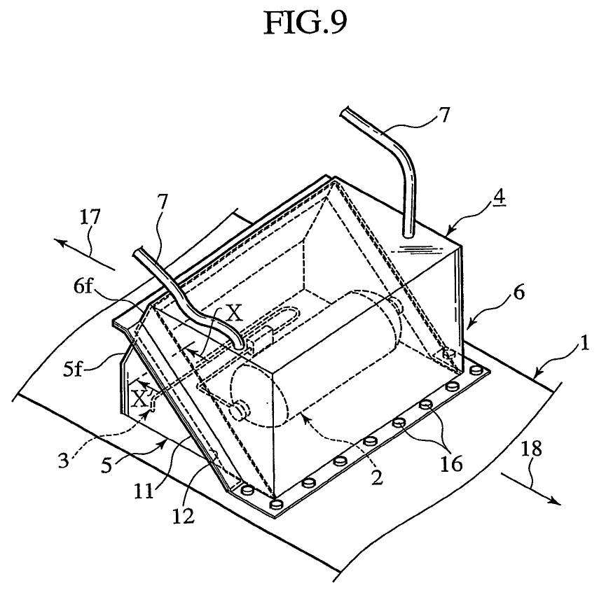

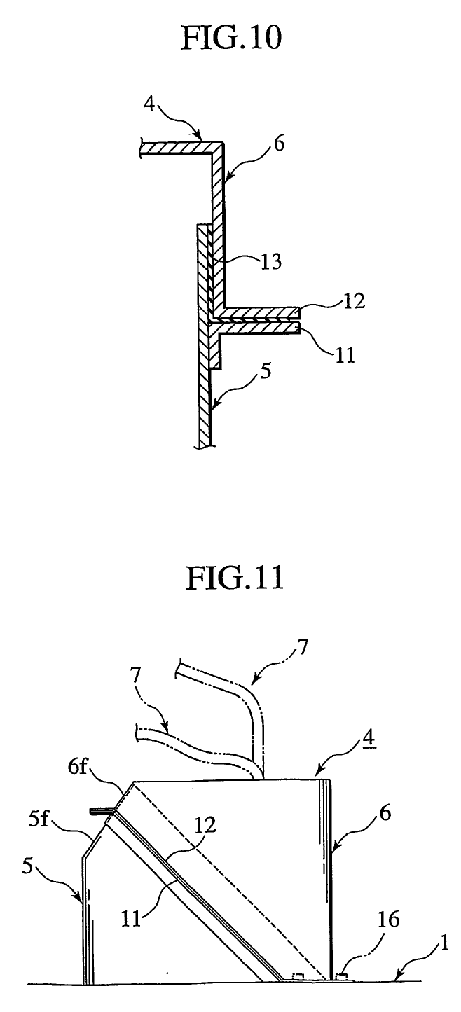

FIGS. 9 toll show a fourth embodiment of the present invention. In the fourth embodiment, on an outer face in the vicinity of the aperture edge of the lower box 5 in the third embodiment, a flange 11 is formed along the aperture edge. A peripheral flange 12 is formed on the aperture peripheral edge of the upper box 6 so as to overlap the flange 11 of the lower box 5 and the floor 1. In a space between mating faces of the lower box 5 and the upper box 6 and in a space between overlapping faces of the flange 11 of the lower box 5 and the peripheral flange 12 of the upper box 6, a sealing member 13 is interposed. The upper box 6 is fastened and thereby fixed to the floor 1 via the peripheral flange 12 at a lower slanted end portion thereof, which is the back end of the aperture edge thereof, with the bolts and the nuts 16.

Therefore, similar effects to those in the third embodiment can be obtained according to the structure of the fourth embodiment. In addition, the sealing member 13 is interposed across the space between the mating faces of the lower box 5 and the upper box 6 and the space between the overlapping faces of the flange 11 of the lower box 5 and the peripheral flange 12 of the upper box 6. Accordingly, effluence of the fuel gas through a path formed between these mating faces of the lower box 5 and the upper box 6 can be securely prevented.

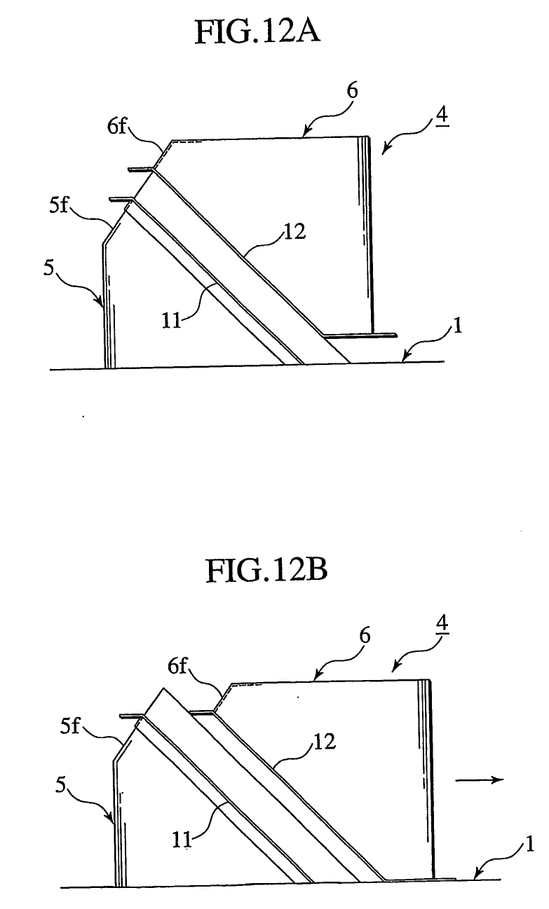

FIGS. 12A and 12B show operation modes of mounting or detaching the upper box 6 into or out of the lower box 5. As it has been described in the third embodiment, it is possible to conduct an operation of fitting or detaching the upper box 6 by slidably mounting the lower edge of the front end of the upper box 6 onto the slanted aperture edge of the lower box 5. In the fourth embodiment, the peripheral flange 12 protrudes from the aperture edge of the upper box 6. Accordingly, it is possible to suppress detachment of the upper box 6 from the slanted aperture edge of the lower box 5 during the sliding operation. Therefore, it is possible to further enhance workability upon mounting or detaching the upper box 6.

The entire content of a Japanese Patent Application No. P2001-312685 with a filing date of Oct. 10, 2001 is herein incorporated by reference.

Although the invention has been described above by reference to certain embodiments of the invention, the invention is not limited to the embodiments described above will occur to these skilled in the art, in light of the teachings. The scope of the invention is defined with reference to the following claims.

### INDUSTRIAL APPLICABILITY

As described above, according to the present invention, in a case where the fuel gas such as hydrogen leaks out from the fuel tank or the fuel supply pipe connected thereto, the fuel gas, having the small molecular weight, is oriented upward and discharged out of the vehicle via the ventilation pipe above the housing box.

This housing box houses the fuel tank by fitting the upper box to the outside of the lower box on the floor. Accordingly, the space between the overlapping mating faces of the lower box and the upper box may constitute a communication path for the fuel. However, the path in the direction from the inside of the housing box toward the outside constitutes a downward path in the space between the mating faces. Accordingly, the fuel gas with the small molecular weight such as hydrogen does not easily enter the space between the mating faces in a downward direction. Therefore, the fuel gas traces a discharge path through the ventilation pipe as described above. As a result, it is possible to prevent the fuel gas from flowing into the compartment, and thereby to enhance security.

As described above, the housing box has a constitution in which the lower box to be fixed to the floor and the upper box to be covered thereon are provided separately. Accordingly, it is possible to conduct inserting and detaching of the fuel tank or the maintenance operation of the fuel supply pipe easily by detaching the upper box.

1. A fuel tank mounting structure, comprising:
a lower box fixed to the floor in a rear portion of a vehicle body for surrounding a fuel tank disposed thereon;
an upper box mounted to the outside of the lower box for enclosing the fuel tank;
a housing box having the lower box and the upper box; and
a ventilation pipe provided on the upper box for connecting an inner side of the housing box and an outer side of a vehicle.

2. A fuel tank mounting structure according to claim 1,
wherein the housing box is formed as a plane quadrangle, and
a mating face at one of a pair of mutually opposite side portions where the lower box and the upper box overlap each other is made as a inclined plane.

3. A fuel tank mounting structure according to claim 2,
wherein a side portion opposite to the side portion formed as an inclined plane is made open in the lower box, and
a side portion of the upper box corresponding to the open side portion of the lower box includes an extended portion for covering the open side portion.

4. A fuel tank mounting structure according to claim 3, further comprising;
a flange formed along an aperture edge of the lower box on an outer face of the vicinity thereof;
a peripheral flange formed on a peripheral edge of an aperture of the upper box for overlapping the flange and the floor; and
a sealing member interposed between the mating faces of the lower box and the upper box, and between overlapping faces of the flange and the peripheral flange,
wherein the flange and the peripheral flange are fixed to each other.

5. A fuel tank mounting structure according to claim 2,
wherein the lower box and the upper box are constituted separately such that aperture edges of the lower box and the upper box are slanted from the mating face formed as the inclined planes to the floor,
a peripheral flange is formed on an edge portion of the aperture edge of the upper box contacting with the floor, and the upper box is fixed to the floor via the flange.

6. A fuel tank mounting structure according to claim 5, further comprising;
a flange formed along an aperture edge of the lower box on an outer face in the vicinity thereof;
the peripheral flange formed on a peripheral edge of an aperture of the upper box for overlapping the flange and the floor; and
a sealing member interposed between the mating faces of the lower box and the upper box, and between overlapping faces of the flange and the peripheral flange,
wherein the upper box is fixed to the floor via the peripheral flange overlapping the floor.
